(19) United States
(12) Patent Application Publication
(10) Pub. No.: US 2003/0019591 A1
(43) Pub. Date: Jan. 30, 2003

(54) Screen windows for motor vehicles

(76) Inventor: Latonya Christian, Smyrna, GA (US)

Correspondence Address: Latonya Christian, 490 Windy Hill Rd Apt. 914, Smyrna, GA, 30082, US

(21) Appl. No.: 10/176,820

(22) Filed: Jun. 21, 2002

Related U.S. Application Data
(60) Provisional application No. 60/300,167, filed on Jun. 22, 2001.

(51) Int. Cl. A47H 1/00

(52) U.S. Cl. 160/89

(57) ABSTRACT

The Screen Window for Motor Vehicles (18) invention comprises a Screen Window and separate mounting tracks that would adapt to the mounting tracks already installed in the vehicle doors whether power or manual. In the case of a power motor vehicle window the door (10) of the vehicle comprises body (12) a sash (14) a glass window (16) and a Screen Window for Motor Vehicles (18) that slides along two separate guide rails (20) with a thin rubber strip (22) separating the Screen Window for Motor Vehicles (18) and the glass window (16). In an open state, the Screen Window for Motor Vehicles (18) and the glass window (16) will be primarily housed in the body (12). A closed state the Screen Window for Motor Vehicles (18) and the glass window (16) move to a position contacting against the sash (14). The two windows will open and close by a driven motor (24). A passenger will control the action of the windows by using the switch controls labeled Window (1), Screen (3), or Both (5). In the case of a manual motor vehicle window, the glass window (16) and the Screen Window for Motor Vehicles (18) will be mounted on two separate rails (40), which are securely supported within the motor vehicle's body. Two slides (42) will be mounted on the rails (40) allowing the Screen Window for Motor Vehicle (18) and the glass window (16) to slide up or down while being supported by the rails (40). At the upper and lower ends of the rails (40), pulleys (44) are securely fixed, and an intermediate part of the wires (46), which are wound around the pulleys (44) are extended along the rails (40) and joined with the slides (42) at a portion thereof. The end parts of the wires (46) are inserted through guide tubes (48) and joined with a handle unit (50). The handle unit (50) is provided with a handle (not shown in the figure) to be rotated manually by a passenger. A passenger will control the action of the windows by pulling out the handle slightly onto another track extending from the handle shaft.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention is applicable to all motor vehicles such as automobiles, and relates to a manual and power window screen for opening and closing a glass and screen window through manual and power operation. The present invention is intended to provide an alternative to receiving fresh air through other means, e.g. utilizing the air conditioning system. The present invention falls into the class (Class 296) of patents relating to that portion of a land vehicle, which operates as a receptacle or load carrier, together with the top or cover thereof. Which includes modifications to a door (access barrier or closure) in a vehicle body is found within this class (Class 296) when an accessory or a feature correlated to a vehicle body is included.

There are many different types of windows in motor vehicles (e.g. glass, ventilated, etc.), which can cause disadvantages at times. A glass window can only come up or down, if you have the window up then the only air you can receive is if the air condition is utilized. Studies have shown that by constantly utilizing the air conditioning system in a motor vehicle is unsafe for the environment. Motor vehicle air-conditioners use the heat of evaporation of refrigerants to cool the inside of motor vehicles, these refrigerants release CO₂ emissions into the environment. Another disadvantage of constantly using the air conditioning system is the possibility of consuming more fuel. Use of a motor vehicle air conditioner increases load on the engine. This can increase emissions and decrease fuel economy. The use of the air conditioner may increase pollution and waste that occurs when gasoline evaporates from the engine and gas tank. If you have the window down, you will receive air, but you will have the disadvantage of an open window. If a passenger within a motor vehicle wanted to allow fresh air into the vehicle, they would have to lower the glass window, which can cause outside debris to enter the vehicle. Having the window open can also lead to mishaps with children and or pets. An open window can also lead to a possible car jacking or other potential dangers. In the case of a ventilated window a passenger can only open the glass window a little by pushing it forward or outward to receive air.

### BRIEF SUMMARY OF THE INVENTION

The Screen Window for Motor Vehicles has several advantages to the automotive industry. The Screen Window for Motor Vehicles will not only allow fresh air into the vehicle, it will also save the motorist on gasoline because the air conditioner would not need to be utilized. The invention also prevents insects and other objects from flying into the vehicle. The Screen Window for Motor Vehicles will aid in preventing car-jackers and other potential dangers by imposing a barrier other than the glass window between the passengers and the potential threat. The Screen Window for Motor Vehicles will help keep children from hanging out of the windows of the vehicle. The screen would keep passengers from throwing objects from the vehicle. And would prevent pets and children from jumping or hanging out of the window when the vehicle is in motion. Pet owners will also have the advantage of keeping their pets in the car for longer periods of time due to the use of the Screen window. Thus making the Screen Window for Motor Vehicles an asset to the automotive industry.

The applicant herein presents a Screen Window for Motor Vehicles that would be mounted on a separate mounting track from the glass window. The Screen Window for Motor Vehicles will raise or be lowered by Switch Control Panels that are labeled Window (1), Screen (3), or Both (5). The Screen windows would be produced in all different sizes and shapes to accommodate the many different windows within the various motor vehicles.

### BRIEF DESCRIPTION OF THE SEVERAL VIEWS OF THE DRAWING

FIG. 1 Is a left perspective view of the Screen Window for Motor Vehicles of the present invention.

FIG. 2 Is a right perspective view of the Screen Window for Motor Vehicles of the present invention.

FIG. 3 Is a rear view of the lightweight metal frame used for the Screen Window for Motor Vehicles.

FIG. 4 Is a top view of the lightweight metal frame used for the Screen Window for Motor Vehicles.

FIG. 5 Is a bottom view of the lightweight metal frame used for the Screen Window for Motor Vehicles.

FIG. 6 Is a front view of the lightweight metal frame used for the Screen Window for Motor Vehicles.

FIG. 7 Is a view of the fine, wire mesh screen used for the Screen Window for Motor Vehicles.

FIG. 8 Is a schematic drawing of the Screen Window for Motor Vehicles opening and closing apparatus of the power window concerning the present invention.

FIG. 9 Is a view of the Switch control panels for all doors within a motor vehicle of the present invention.

FIG. 10 Is a view of the Driver's Switch control panel of the present invention.

FIG. 11 Is a view of the passenger Switch control panels of the present invention.

FIG. 12 Is a schematic drawing of the Screen Window for Motor Vehicles opening and closing apparatus of the manual window concerning the present invention.

### DETAILED DESCRIPTION OF THE INVENTION

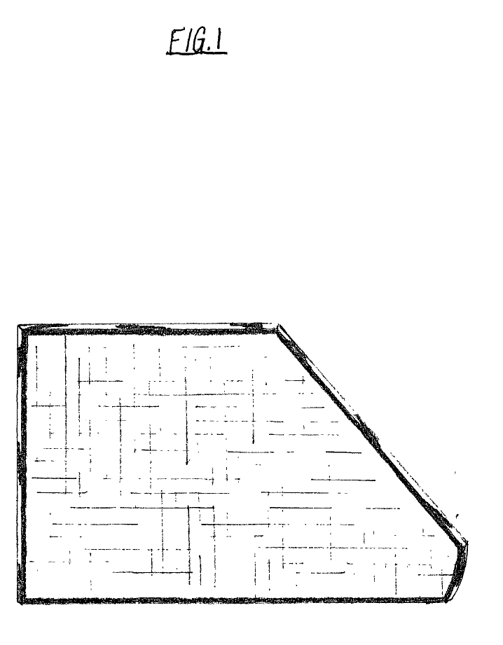

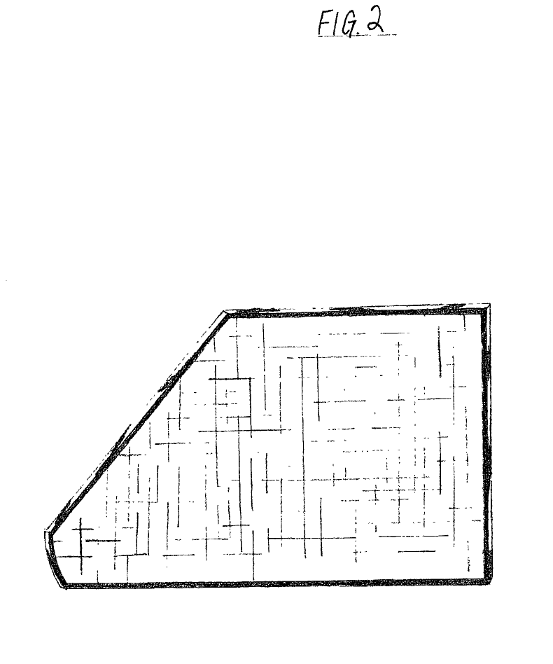

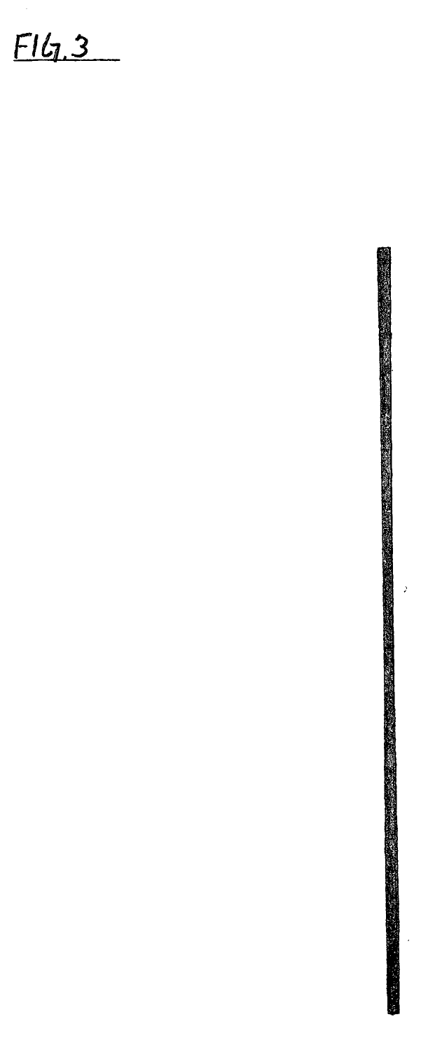

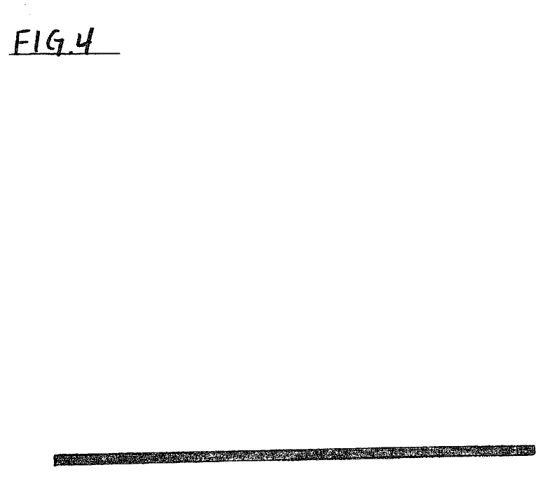

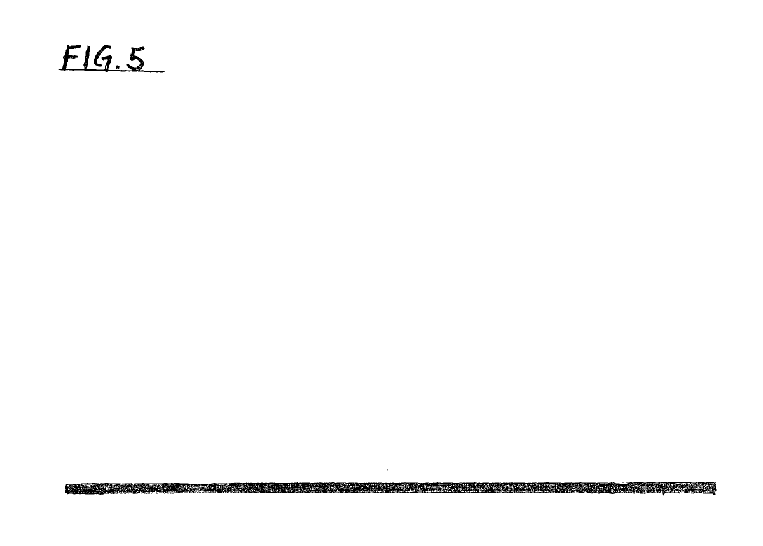

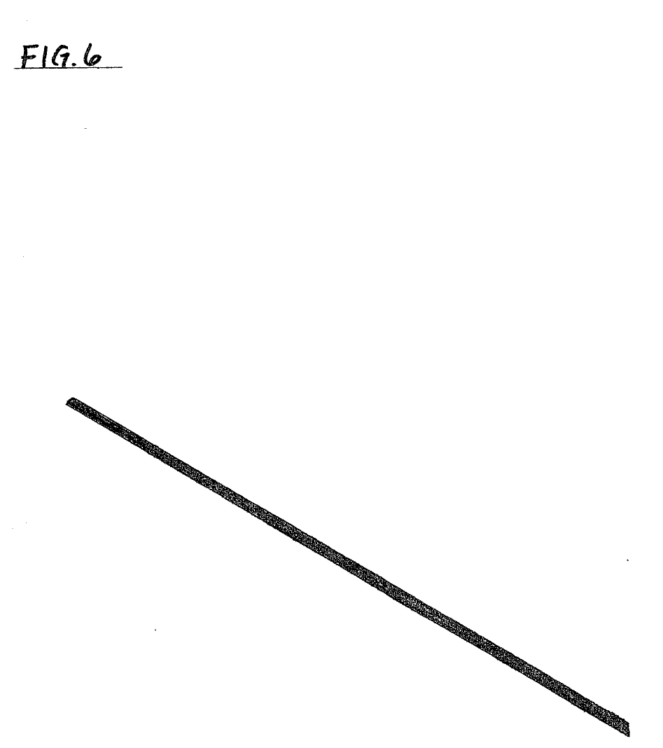

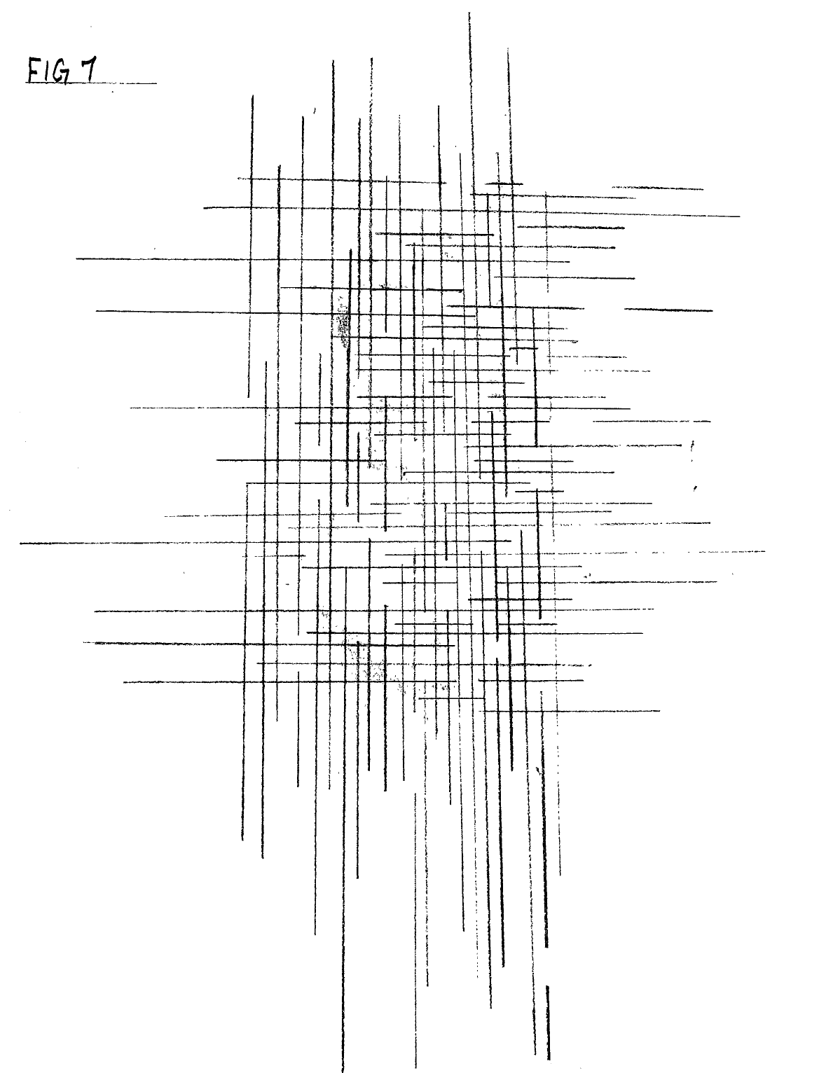

With reference to the drawings, embodiments of the present invention will be described in this section. FIG. 1 is a left perspective view of the screen window related to the present invention. FIG. 2 is a right perspective view of the screen window. FIG. 3 is a rear view of the lightweight metal frame used for the screen window. FIG. 4 is a top view of the lightweight metal frame used for the screen window. FIG. 5 is a bottom view of the lightweight metal frame used for the screen window. FIG. 6 is a front view of the lightweight metal frame used for the screen window. FIG. 7 is a view of the fine, wire mesh screen used for the screen window. The wire mesh would be contained inside a lightweight metal frame (FIGS. 3-6).

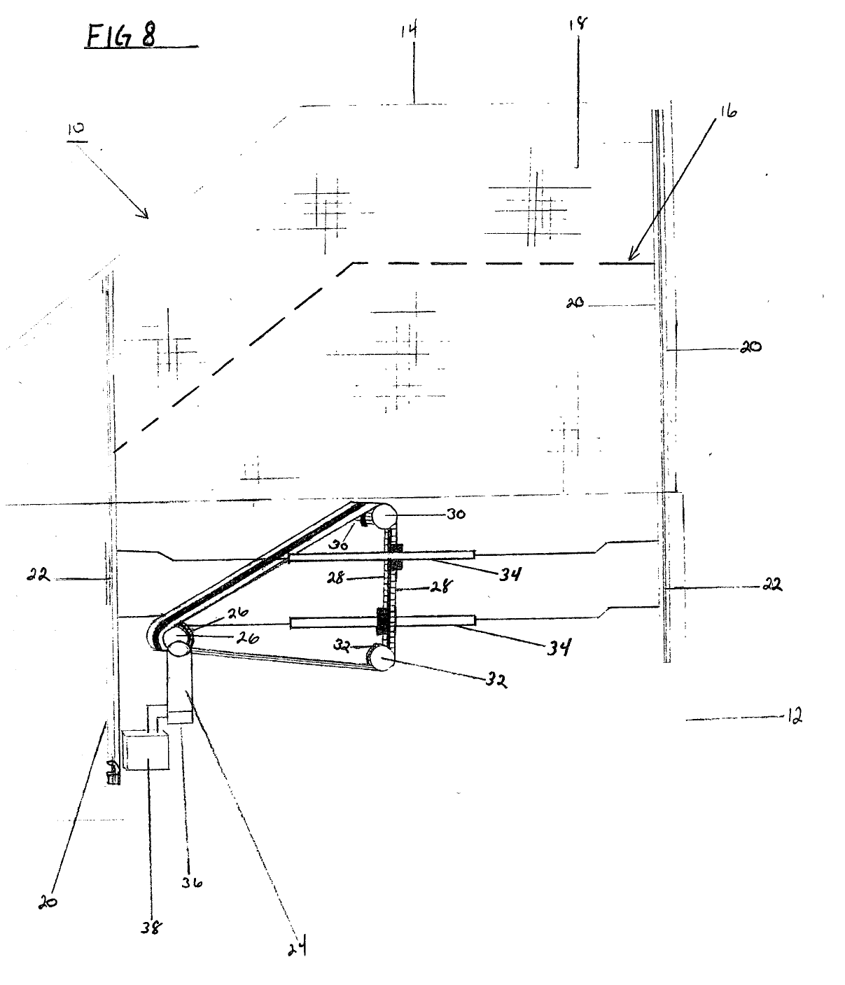

FIG. 8 shows a schematic drawing of the Screen Window for Motor Vehicles for a vehicle with power windows. The door (10) of the vehicle comprises body (12) a sash (14) a glass window (16) and a Screen Window for Motor Vehicles (18) that slides along two separate guide rails (20) with a thin rubber strip (22) separating the Screen Window for Motor Vehicles (18) and the glass window (16). In an open state, the Screen Window for Motor Vehicles (18) and the glass window (16) will be primarily housed in the body (12). A closed state the Screen Window for Motor Vehicles (18) and the glass window (16) move to a position contacting against the sash (14). The two windows will open and close by a driven motor (24). The motor (24) is installed within the body (12) and oriented so that it's drive shaft lies substantially within the page plane of FIG. 8. The rotation of the motor drive shaft is transmitted, through a worm gear, two separate toothed drive pulleys (26) comprising a rotating shaft that is perpendicular to the page plane. Two separate toothed belts (28) have been placed around the drive pulleys (26) and four driven pulleys (30, 32), which are arranged at the top and bottom within the door's body (12). Two support brackets (34) will support the bottom edge of the Screen Window for Motor Vehicles (18) and the glass window (16) is further secured onto the toothed belts (28). Therefore, the toothed belts (28) rotate with the rotation of the motor (24), thereby raising and lowering the support brackets (34) between the driven pulleys (30, 32). The speed that the window is raised at is controlled by the sensor (36). This accomplishes the opening and closing of the Screen Window for Motor Vehicles (18) and the glass window (16).

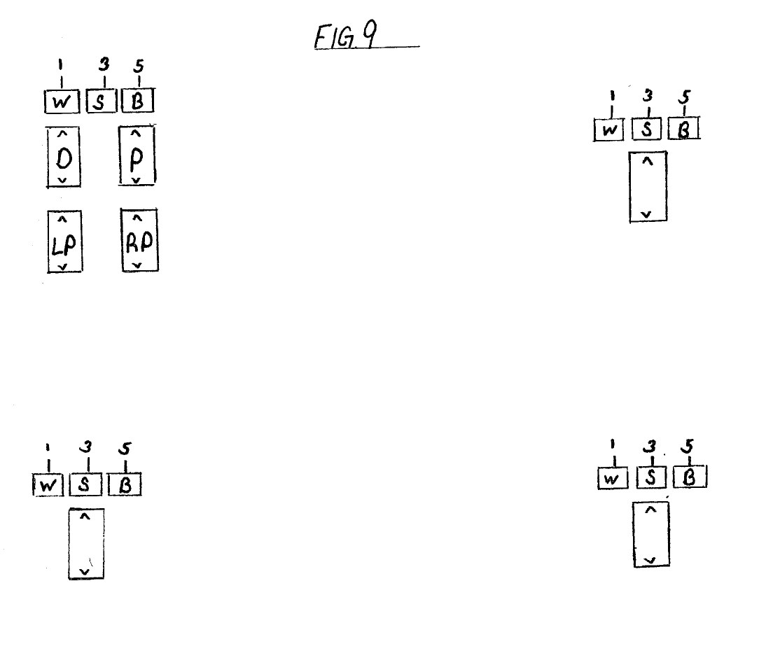

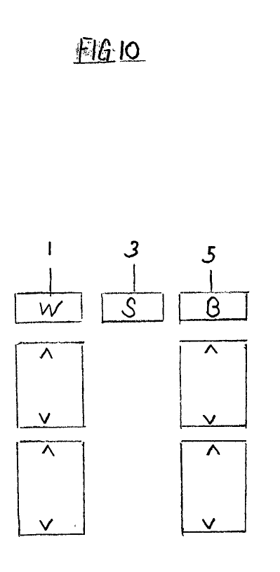

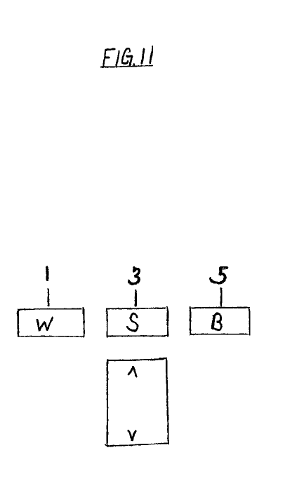

FIG. 9 is a view of the switch control panels for all doors within a motor vehicle. The Switch Control Panel within the vehicle would feature three push button control switches horizontally aligned (FIGS. 10-11) that would be used to select the Window glass (1), Screen (3) or Both (5) (FIGS. 10-11). The first switch control is labeled Window (1) and would control the raising or lowering of the conventional glass window. The second switch control, labeled Screen (3) would control the raising or lowering of the screen window. The third switch control is labeled Both (5) and would be used to simultaneously raise or lower the screen and glass window. The switches would be connected to the vehicular electrical power (FIG. 8) and would apply the power to the bi-directional drive whenever a switch was activated.

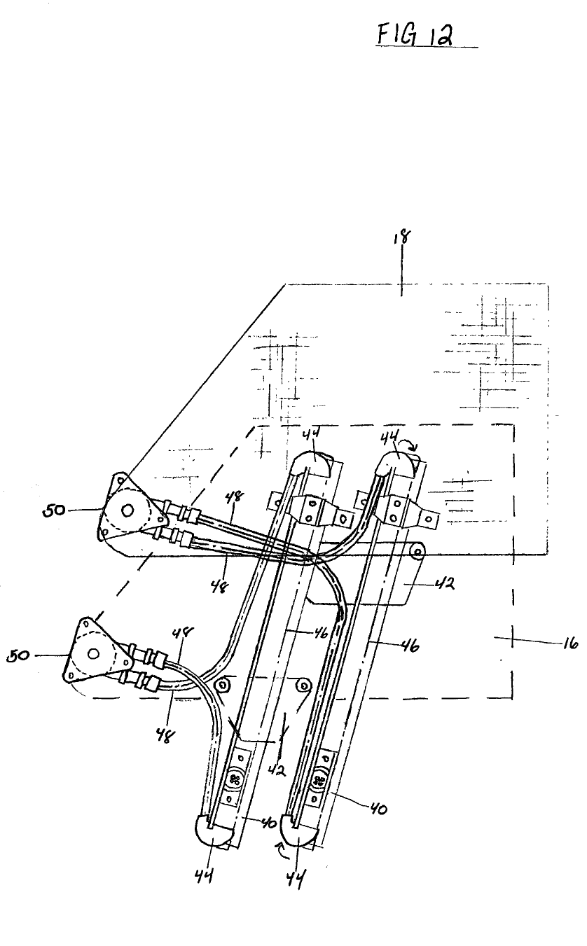

FIG. 12 shows a schematic drawing of the Screen Window for Motor Vehicles and the manual window apparatus for opening and closing. The glass window (16) and the Screen Window for Motor Vehicles (18) will be mounted on two separate rails (40), which are securely supported within the motor vehicle's body. Two slides (42) will be mounted on the rails (40) allowing the Screen Window for Motor Vehicle (18) and the glass window (16) to slide up or down while being supported by the rails (40). At the upper and lower ends of the rails (40), pulleys (44) are securely fixed, and an intermediate part of the wires (46), which are wound around the pulleys (44) are extended along the rails (40) and joined with the slides (42) at a portion thereof. The end parts of the wires (46) are inserted through guide tubes (48) and joined with a handle unit (50). The handle unit (50) is provided with a handle (not shown in the figure) to be rotated manually by a passenger. In order for a passenger to raise or lower the Screen Window for Motor Vehicles (18), the handle will be pulled out slightly onto another track extending from the handle shaft. Unlike the power window example simultaneous raising and lowering will not occur.

1. What I, Latonya P. Christian, claim as my invention is the Screen Window for Motor Vehicles, stated in a provisional patent which is already on file in my name. The invention is a screen window made of fine, wire mesh (FIG. 7) that would provide fresh air into the motor vehicle without having to utilize the air conditioning system. The Screen window is designed to work inside vehicles with power or manual window systems. The Screen Window for Motor Vehicles (18) and the glass window (16) would be mounted on separate mounting tracks. The Screen Window for Motor Vehicles (18) will raise or be lowered by Switch Control Panels (FIG. 9) that are labeled Window (1), Screen (3), or Both (5). The advantage of having the Screen Window for Motor Vehicles (18) is that motorists will have the option to ride with the screen up and the glass window (16) down allowing fresh air into the vehicle, preventing insects, car jackers, and other unwanted objects from entering the vehicle. Keeping children, pets, toys, and other objects from flying out of the window, at the same time still allowing fresh air into the vehicle.
